(19) United States
(12) Patent Application Publication
(10) Pub. No.: US 2021/0080670 A1
(43) Pub. Date: Mar. 18, 2021

(54) FIBER-OPTIC CONNECTION ASSEMBLIES, FEATURES, COMPONENTS, AND METHODS

(71) Applicant: COMMSCOPE TECHNOLOGIES LLC, Hickory, NC (US)

(72) Inventors: Thomas A. THIGPEN, Highland Village, TX (US); Oscar Fernando BRAN DE LEÓN, Belle Plaine, MN (US); Thomas MARCOUILLER, Shakopee, MN (US)

(73) Assignee: COMMSCOPE TECHNOLOGIES LLC, Hickory, NC (US)

(21) Appl. No.: 16/640,318

(22) PCT Filed: Aug. 24, 2018
(86) PCT No.: PCT/US2018/047872

§ 371 Date: Feb. 19, 2020

Related U.S. Application Data
(60) Provisional application No. 62/549,591, filed on Aug. 24, 2017.

(51) Int. Cl. G02B 6/44; G02B 6/38

(52) U.S. Cl. CPC G02B 6/4471; G02B 6/4469; G02B 6/387; G02B 6/3893; G02B 6/3897; G02B 6/3825

(57) ABSTRACT

A fiber-optic connection assembly including a cable, a fiber-optic connector and an adapter. The cable terminates with the fiber-optic connector. The fiber-optic connector is removably connected to the adapter with a fastener. The fiber-optic connection assembly also includes a cover that is configured to inhibit access to the fastener. The cover includes a passageway that is configured to removably receive at least a portion of the fiber-optic connector and at least a portion of the adapter.

### CROSS-REFERENCE TO RELATED APPLICATION

This application is being filed on Aug. 24, 2018 as a PCT International Patent Application and claims the benefit of U.S. Patent Application Ser. No. 62/549,591, filed on Aug. 24, 2017, the disclosure of which is incorporated herein by reference in its entirety.

### TECHNICAL FIELD

The present disclosure relates generally to assemblies, features, components, and methods related to fiber-optic connections and more particularly to inhibit unintended access to fiber-optic connections.

### BACKGROUND

Fiber-optic cable connection systems can be used to facilitate connecting and disconnecting fiber-optic cables in the field. An example fiber-optic cable connection system for mating adjacent ends of two fiber-optic cables can include fiber-optic connectors mounted at the adjacent ends of the fiber-optic cables, and a fiber-optic adapter for mechanically and optically coupling the fiber-optic connectors together. An example includes fiber-optic cables routed from a central location (e.g., a service provider's central office) to a fiber distribution hub located in a local area such as a multi-unit building or neighborhood. In the example, fibers are then routed from the fiber distribution hub to subscriber locations (e.g., homes, apartments or businesses) using various techniques.

For example, a stub cable carrying multiple optical fibers can be routed from an optical fiber breakout location of the distribution hub to a drop terminal. Drop cables, each carrying an optical fiber, can be run from the drop terminal to optical network terminals located at a plurality of premises near the drop terminal. A fiber-optic connection system can be used to connect the broken-out optical fibers in the stub cable and the optical fibers in the drop cables at a multiport service terminal, which allows for multiple drop cables to be connected.

Multiport service terminals can be located closer to subscriber locations, and therefore further away from the service provider's central office. As a result, the service provider is sometimes unable to continuously monitor each multiport service terminal to ensure that a proper fiber-optic connection is maintained by each drop cable to the multiport service terminal. In this case, incidental or intentional interference with the fiber-optic connection at the multiport service terminals can be possible. Consequently, there exists a need to inhibit certain types of unintended, for example accidental or intentional, interference with the fiber optic connection of paired fiber-optic connectors in the field.

### SUMMARY

Aspects of the present disclosure relate to an assembly for inhibiting unintended access to fiber-optic connection assemblies, for example including network or drop terminals which can be secured in remote brackets. Such fiber-optic connection assemblies can include a pair of aligned fiber-optic connectors aligned secured through an adapter. The adapter can secure to the pair of fiber-optic connectors with a fastener. Preferably, a connection between fiber optic connectors communicating information across optically engaging optical fibers is maintained. The present disclosure relates to different embodiments of covers which releasably inhibit access to the connection between connected fiber-optic connectors. Example embodiments include covers which releasably cover the fiber-optic connectors and an adapter in a collar or sleeve-like geometry. These collar or sleeve-like covers can be releasably secured onto and removed from the fiber-optic connectors and adapter. Preferably, the collar or sleeve-like covers can be removably secured over adapters. These collar or sleeve-like covers can have a single rigid body or a hinged clamshell-type structure. An alternative cover can have a shroud-like structure supported by an anchor and tether, which are releasably fixed between the drop terminal and the bracket. The shroud-like structure fits over the fiber-optic connection to inhibit unintended access.

In one aspect, the present disclosure relates to a fiber-optic connection assembly that includes a cable, a fastener, a fiber-optic connector and an adapter. The cable terminates with the fiber-optic connector and extends away from the adapter. The fiber-optic connector is removably connected to the adapter with the fastener. The adapter includes a protrusion. The fiber-optic connection assembly also includes a cover that has a movement-inhibition arrangement. The cover is removably mounted over the fastener, and the cover is configured to inhibit unintended access to the fastener.

In another aspect, the present disclosure relates to a fiber-optic connection assembly which includes a terminal, a bracket, an adapter, a fastener and a fiber-optic connector. The terminal is removably secured to the bracket. The adapter is supported by the terminal, and the fiber-optic connector is removably connected to the adapter with the fastener. The fiber-optic connection assembly also includes a cover that is configured to removably inhibit unintended access to the fastener when the terminal is secured to the bracket. The cover includes a passageway which is configured to removably receive at least a portion of the fiber-optic connector and at least a portion of the adapter.

In another aspect, the present disclosure relates to a kit of parts that is intended for forming a fiber-optic connection assembly. The kit includes a cable terminating with a fiber-optic connector, a fastener, an adapter that is intended to be removably connected to the fiber-optic connector with the fastener, and a cover that is intended to removably inhibit unintended access to the fastener. The adapter includes a protrusion. The cover is intended to be inhibited from axial movement along the first cable through engagement with the protrusion on the adapter.

In another aspect, the present disclosure relates to a method for assembling a fiber-optic connection assembly. The method includes removably fastening a fiber-optic connector to an adapter with a fastener. The fiber-optic connector terminates a cable. The method also includes removably covering at least a portion of the fiber-optic connector and at least a portion of the adapter with a cover, inhibiting axial movement of the cover along the cable by engaging the protrusion on the adapter, and inhibiting unintended access to the fastener with the cover.

In another aspect, the present disclosure relates to a method for disassembling a fiber-optic connection assembly. The method includes disengaging a cover from a protrusion on an adapter in fastened engagement with a fiber-optic connecter terminating a cable, uncovering the adapter and the fiber-optic connector by moving the cover along the cable, and releasing the adapter and the fiber-optic connector from fastened engagement by actuating a fastener operably included in the fiber-optic connection assembly.

In another aspect, the present disclosure relates to a fiber-optic connection assembly that includes a cable, a fiber-optic connector, a fastener and an adapter. The cable terminates with the fiber-optic connector. The fiber-optic connector is removably connected to the adapter with the fastener. The fiber-optic connection assembly also includes a cover that is configured to inhibit unintended access to the fastener. The cover includes a passageway that is configured to removably receive at least a portion of the fiber-optic connector and at least a portion of the adapter.

### BRIEF DESCRIPTION OF THE DRAWINGS

FIG. 1 is a schematic diagram of a fiber-optic connection assembly according to an example embodiment of the present invention.

FIG. 2 is an exploded schematic diagram of the fiber-optic connection assembly shown in FIG. 1.

FIG. 3 is a perspective schematic diagram of a fiber-optic connection assembly according to another example embodiment of the present disclosure; illustrating the fiber-optic connection assembly in use with a multi-port terminal and bracket.

FIG. 4 is a perspective schematic diagram of the fiber-optic connection assembly shown in FIG. 3, shown isolated from the multi-port terminal and bracket.

FIG. 5 is a side cross-sectional schematic diagram of the fiber-optic connection assembly shown in FIG. 4.

FIG. 6 is a perspective schematic diagram of the fiber-optic connector and adapter structure from the fiber-optic connection assembly shown in FIG. 4, shown with the example cover removed.

FIG. 7 is a perspective schematic diagram of the fiber-optic connection assembly shown in FIGS. 4-6, shown with the example cover and adapter removed.

FIG. 8 is an isolated top perspective schematic diagram of the example cover shown in FIG. 4.

FIG. 9 is a bottom perspective schematic diagram of the example cover shown in FIG. 8.

FIG. 10 is a schematic diagram of another example cover which can function with the fiber-optic connector and adapter structure shown in FIG. 6; the cover shown in an open position.

FIG. 11 is an isolated perspective schematic diagram of the example cover shown in FIG. 10, shown in the open position.

FIG. 12 is a top perspective schematic diagram of the cover shown in FIGS. 10-11, the cover shown in a closed position.

FIG. 13 is a side perspective schematic diagram of a fiber-optic connection assembly according to another example embodiment of the present disclosure; illustrating another example cover and the multi-port terminal shown in FIG. 3.

FIG. 14 is an isolated perspective schematic diagram of the cover shown in FIG. 13.

### DESCRIPTION OF EXAMPLE EMBODIMENTS

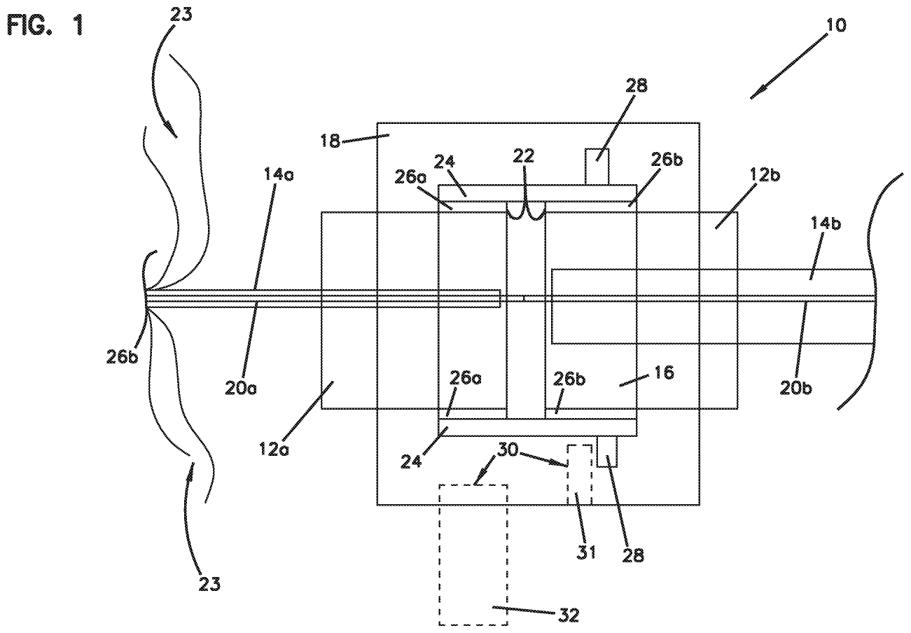

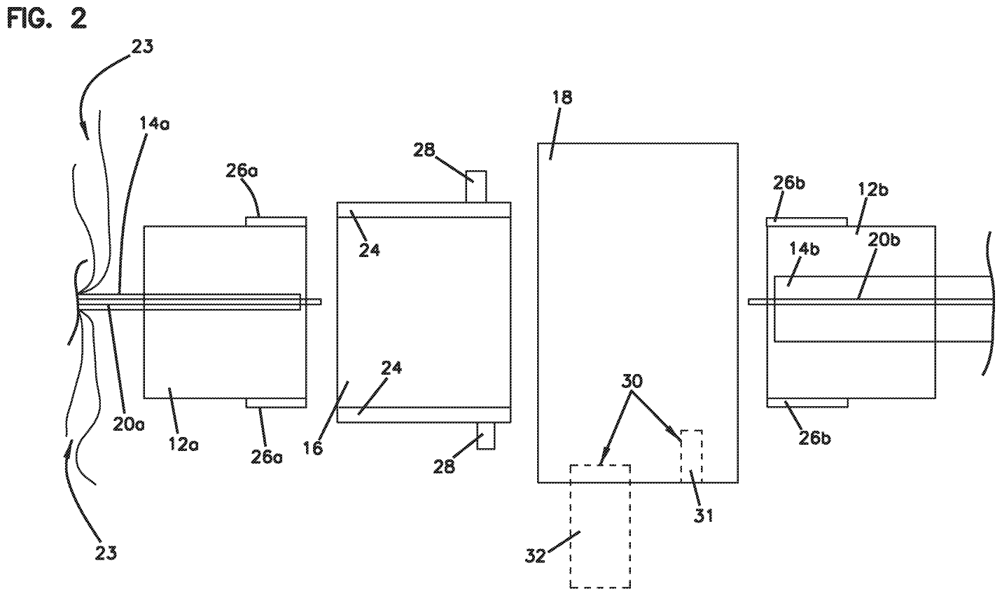

### I. General Concepts: FIGS. 1 and 2

### A. Fiber-Optic Connection Assembly

FIGS. 1 and 2 illustrate an example fiber-optic connection assembly 10. The fiber-optic connection assembly 10 can include a pair of fiber-optic connectors 12a & 12b, a pair of fiber-optic cables 14a & 14b and an adapter 16. The fiber-optic connectors 12a & 12b are supported at the terminal ends of the pair of fiber-optic cables 14a & 14b. The illustrated pair of fiber-optic connectors 12a & 12b is secured to the adapter 16 such that the pair of fiber-optic connectors is aligned with each other.

In one example, a first 12a of the pair of fiber-optic cables can be a breakout cable and a second 12b of the pair of fiber-optic cables can be a drop cable. The example first (breakout) cable 14a can function to carry one 20a of a plurality 23 of optical fibers broken out from a multi-fiber cable, sometimes referred to as a stub cable, to a designated fiber-optic connection location. The example second (drop) cable 14b can function to carry an optical fiber 20b from the designated fiber-optic connection location to an optical network terminal, for example an end-user premises.

The pair of fiber-optic connectors 12a & 12b function to secure to the adapter 16 with a fastener assembly 22. An example fastener assembly 22 functions to releasably secure the pair of fiber-optic connectors 12a & 12b to the adapter 16. For example, the illustrated fastener assembly 22 can include correspondingly-engaging surfaces. Example correspondingly-engaging surfaces can include a first surface 24 on the adapter 24 and second surfaces 26a & 26b on the fiber-optic connectors. The correspondingly-engaged surfaces 24, 26a & 26b can be a threaded surface on the adapter 16 and correspondingly threaded surfaces on the fiber-optic connectors 12a & 12b. The fiber optic connectors 12a & 12b can be threaded into connection with the adapter 16, and reversibly removed from threaded connection with the adapter. Alternatively, the fastener assembly 22 can include corresponding snap engagement elements, corresponding key and keyway elements, or a similar assembly which functions to releasably secure the pair of fiber-optic connectors 12a & 12b to the adapter 16.

As particularly illustrated in FIG. 1, when the pair of fiber-optic connectors 12a & 12b are secured to the adapter 16, the optical fibers 20a & 20b carried within the fiber-optic cables 14a & 14b are aligned to optically engage with each other. When in optical engagement, the optical fibers 20a & 20b can communicate data from the optical fiber in one fiber-optic cable to the optical fiber in the other fiber-optic cable, and vice versa. Conversely, when the optical fibers 20a & 20b are not in optical engagement, for example if one or both of the fiber-optic connectors 12a & 12b are not connected to the adapter 16, such data communication is not provided.

To maintain optical engagement between the optical fibers 20a & 20b, the fiber-optic connectors 12a & 12b should preferably remain connected in alignment to the adapter 16. However, the connection between the fiber-optic connector 12b on the drop cable 14b and the adapter 16 can be accidentally or undesirably accessed and manipulated, thus possibly causing a disconnection of the fastener 22, and a misalignment of the optical fibers 20a & 20b.

The fiber-optic connection assembly 10 also includes a cover 18, which functions to inhibit unintended access to the fastener 22 by covering at least a portion of the adapter 16 and the second fiber-optic connector 12b. For example, unintended access can include access other than by intended users such as those installing or maintaining the fiber-optic connection assembly 10. The cover 18 can have any structure and/or geometry, as long as the cover 18 functions to inhibit access to the fastener 22. Preferably, the cover 18 has a structure and/or geometry that shields/hides at least the fastener 22 from access, and more preferably shields/hides at least the fastener from access radially with respect to the fiber-optic connection assembly 10.

The cover 18 is also inhibited from unintended removal from a mounted position over the adapter 16 and the second fiber-optic connector 12b. The cover 18 can inhibit this unintended removal with a movement-inhibition arrangement 30 (or retainer).

In one option, the movement-inhibition arrangement 30 can be a protrusion-engagement arrangement 31 that engages a protrusion 28 on the adapter 16. For example, the protrusion-engagement arrangement 31 extends from the cover 18 to engage the protrusion 28 on the adapter 16 once the cover is in a mounted position to inhibit unintended access to the fastener 22. Once positioned to inhibit unintended access to the fastener 22, the illustrated cover 18 is inhibited from axial movement along the fiber-optic cable 14b away from the adapter 16 by the protrusion-engagement arrangement 31 on the cover coming into engagement with the protrusion 28 on the adapter 16.

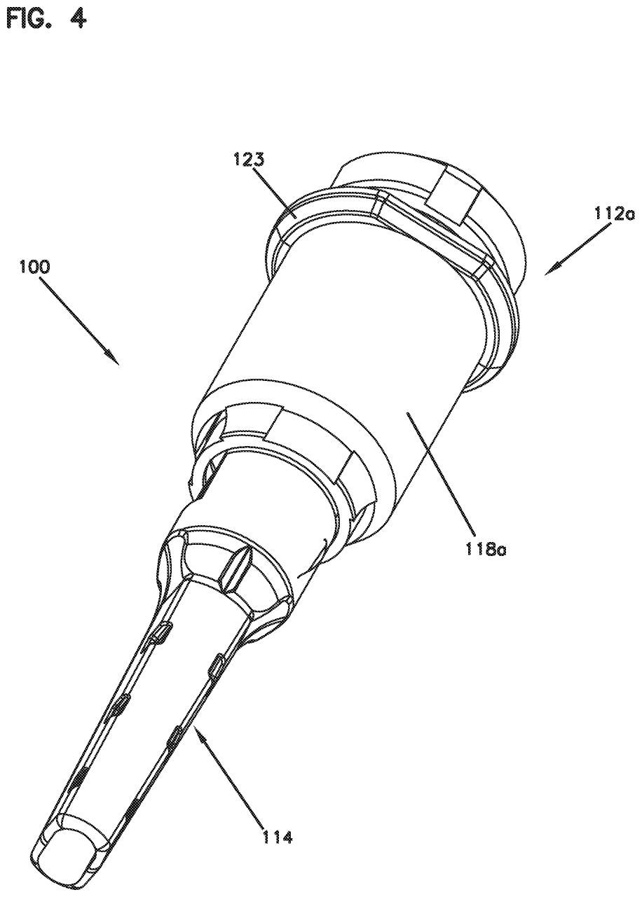

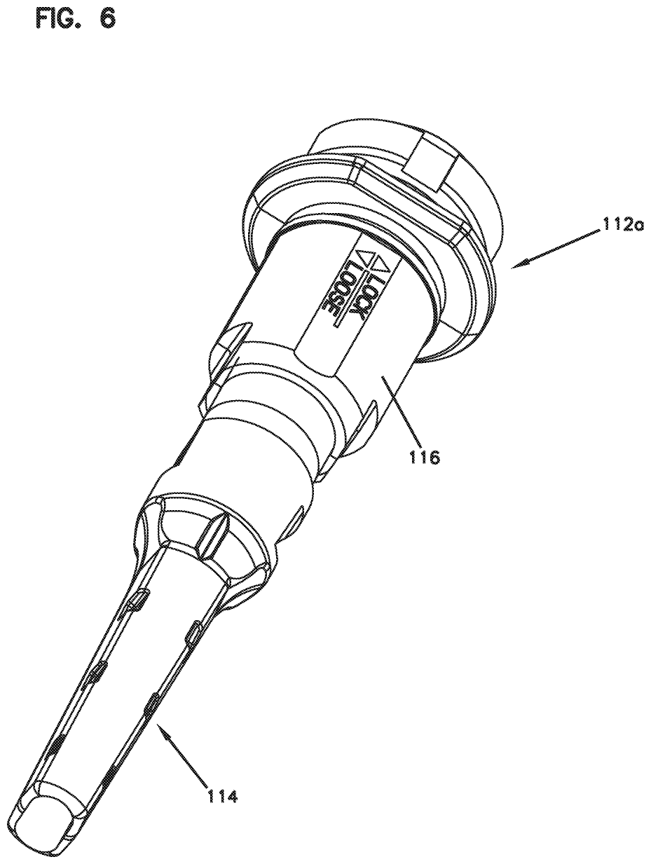

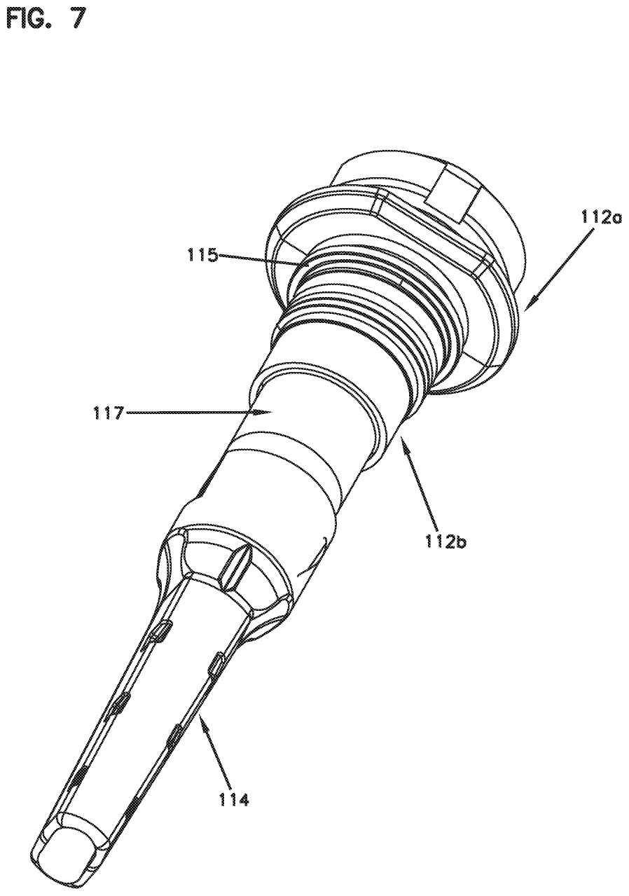

The cover 18 can be removed from inhibiting unintended access to the fastener 22, for example by disengaging the protrusion-engagement arrangement 31 on the cover from the protrusion 28 on the adapter 16. The cover 18 can also be repositioned and reused to inhibit access to the fastener 22, without destruction, after the cover has been removed. Example fiber-optic connection assemblies which inhibit axial movement of the cover 18 along the second cable 14b by engaging a protrusion-engagement arrangement 31 with the protrusion 28 are illustrated in greater detail in FIGS. 4-11.

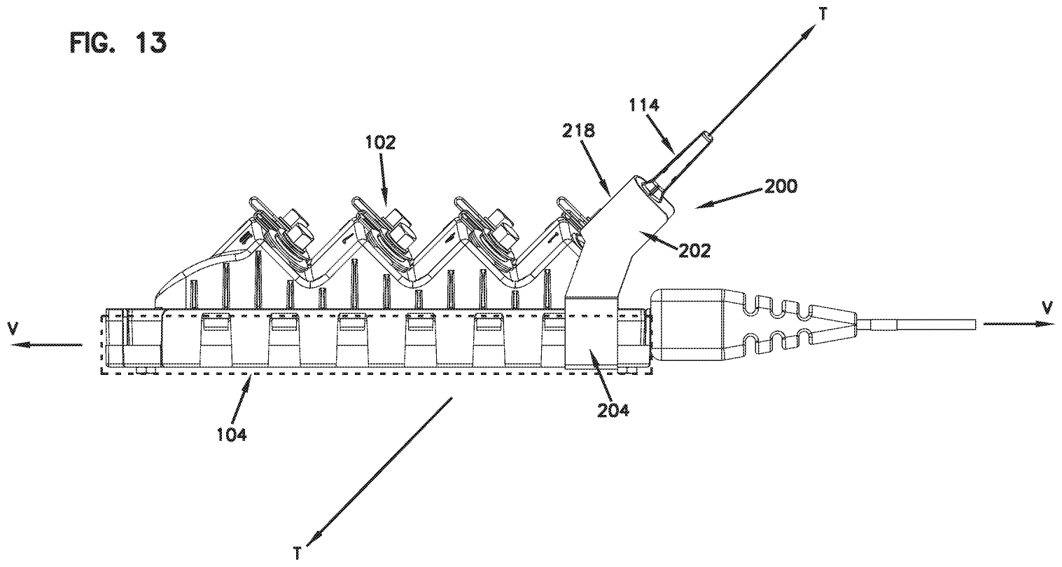

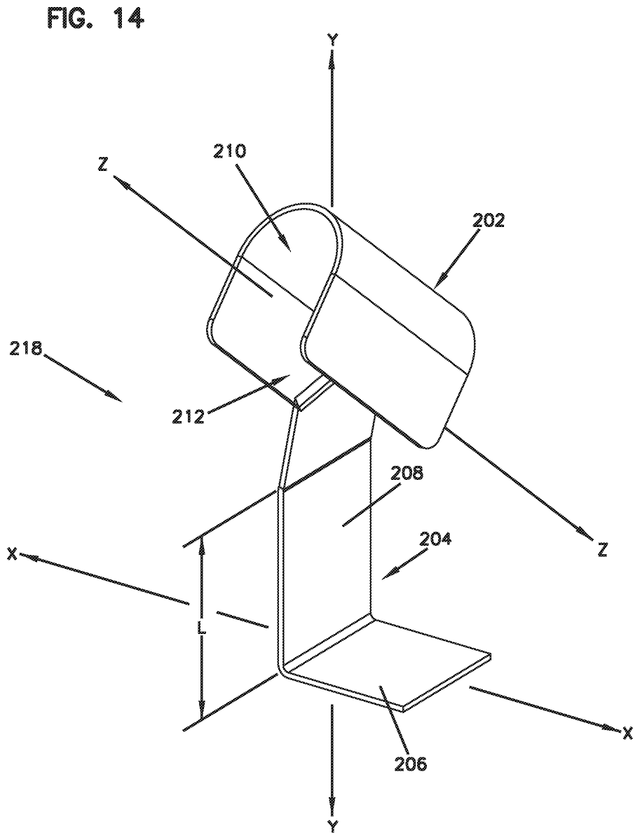

In another option, the movement-inhibition arrangement 30 can be an anchor 32 which fixes the cover 18 in position with respect to the adapter 16 and the second cable 12b. The anchor 32 is releasably fixed with respect to a base structure that supports the fiber-optic connection assembly 10. In this example the cover 18 is also releasably fixed with respect to the base structure. Example fiber-optic connection assemblies which fix the cover 18 with an anchor 32 with respect to a base structure are illustrated in greater detail in FIGS. 13-14.

### II. Example Embodiments

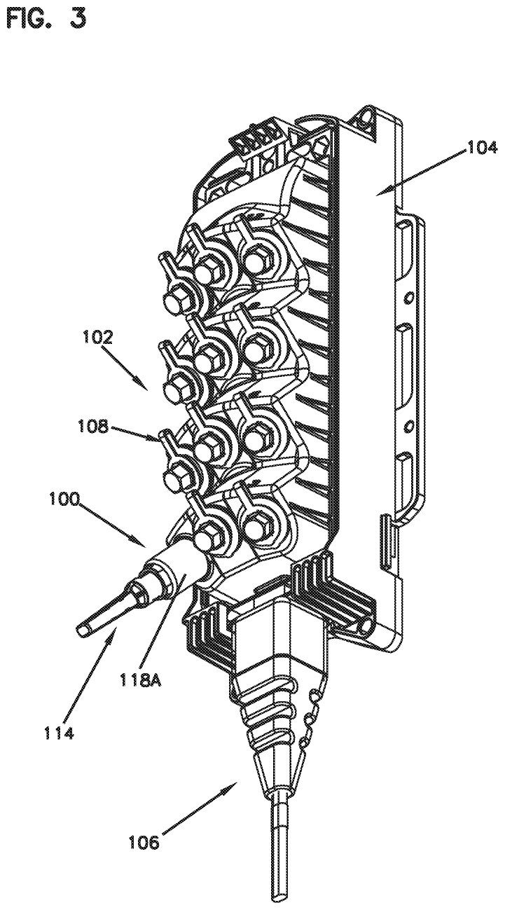

### A: Sleeve Embodiment: FIGS. 3-9

FIGS. 3-12 illustrate an example fiber-optic connection assembly 100, functioning similarly to the fiber-optic assembly 10 described in FIGS. 1 and 2. The illustrated fiber-optic connection assembly 100 includes a cover 118a (or shield) and supports a drop cable 114. As particularly shown in FIG. 3, the illustrated fiber-optic connection assembly 100 can be functionally supported by a base, including a drop terminal 102 removably secured within a bracket 104. The illustrated bracket 104 can be permanently mounted to a fixed surface, for example a wall or a telephone pole. The illustrated bracket 104 can define a receiver or tub for removably securing the drop terminal 102. The illustrated drop terminal 102 can be removably inserted and secured within this terminal 104, for example with a fastener such as a matching male and female clip/snap assembly or a friction fit.

The illustrated drop terminal 102 receives a multi-fiber cable 106 that removably inserts into the drop terminal. The illustrated multi-fiber cable 106 carries a plurality of optical fibers, similarly to the embodiment in FIG. 1, therein. The plurality of optical fibers are broken out from the multi-fiber cable 106 within the drop terminal 102 and one of the optical fibers is directed toward a fiber-optic connection assembly 100. The remaining optical fibers broken out of the multi-fiber cable 106 can each be directed toward one of the remaining plurality of fiber-optic connectors.

The illustrated drop terminal 102 can include at least one, preferably a plurality, of fiber-optic connectors, functioning similarly to the second fiber-optic connectors 12b in FIG. 1. As illustrated, the drop terminal 102 can include a plurality of, for example about 12, fiber-optic connectors.

Each fiber-optic connector in the drop terminal 102 can include a removable cap 108, supported by a fastener such as a ring and tether, which protects a fiber-optic connector during non-use. The cap 108 is secured on or around a cap ring holder 113, such as a flange, shown particularly in FIG. 4.

FIGS. 4-7 illustrate the fiber-optic connection assembly 100 shown in FIG. 3, illustrating a first fiber-optic connector 112a, a second fiber-optic connector 112b, an adapter 116, the cover 118a, and the drop cable 114. Similarly to the embodiment described in FIGS. 1 and 2, the first fiber-optic connector 112a and the second fiber-optic connector 112b are engageably positioned by the adapter 116 such that optical fibers (not shown) travelling respectively therein can optically communicate. Similarly to the embodiment described in FIGS. 1 and 2, the cover 118a is positioned around at least a portion of the adapter 116 and the second fiber-optic connector 112b in order to inhibit access to a fastener, as described above, on the adapter.

The first fiber-optic connector 112a and the second fiber-optic connector 112b can be releasably secured to the adapter 116 with corresponding engagement surfaces, for example similarly to the embodiment described in FIGS. 1 and 2. As illustrated, the first fiber-optic connector 112b can include an engagement surface 115 that includes a threaded surface to releasably engage with a corresponding threaded engagement surface (not shown) on the adapter 116. The second fiber-optic connector 112b has an engagement surface 117 that includes a track and abutment surface. When the adapter 116 is fastened to the engagement surface 115 on the first fiber-optic connector 112a, the adapter is slid along the track and a corresponding abutment element (not shown) on the adapter abuts with the abutment surface of the engagement surface 117 so that when fastened, the adapter prevents the first and second fiber-optic connectors 112a, 112b from being disconnected.

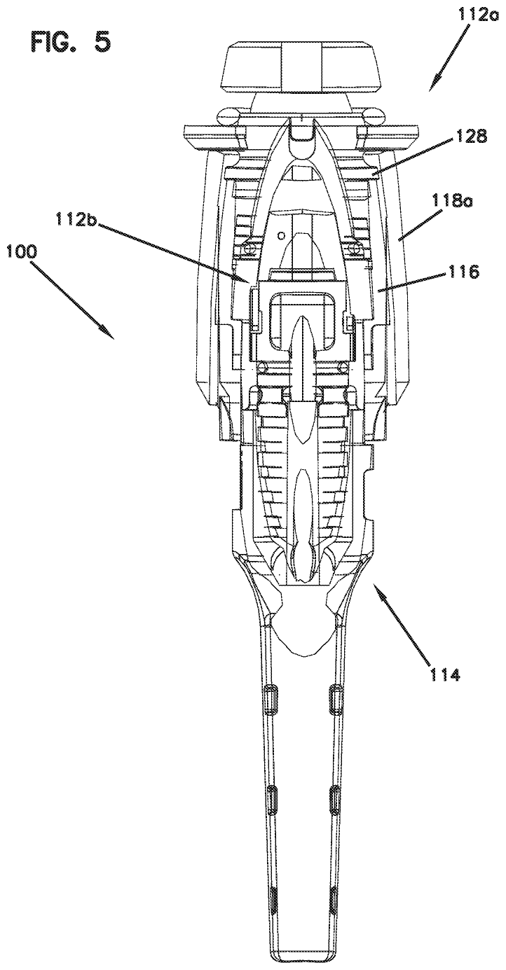

As illustrated particularly in FIG. 5, the adapter 116 includes a protrusion 128, for example a raised circumferential lip extending around the adapter. As illustrated, the adapter 116 can also define a recessed channel which extends circumferentially adjacent to the protrusion 128 to receive a protrusion engagement arrangement on the cover 118a, described further below. The protrusion can alternatively be discontinuous.

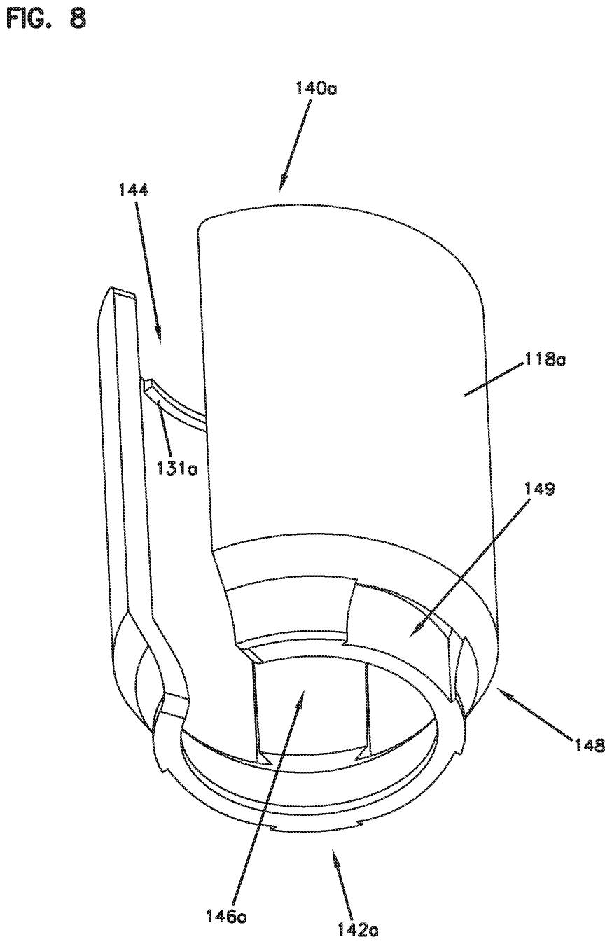

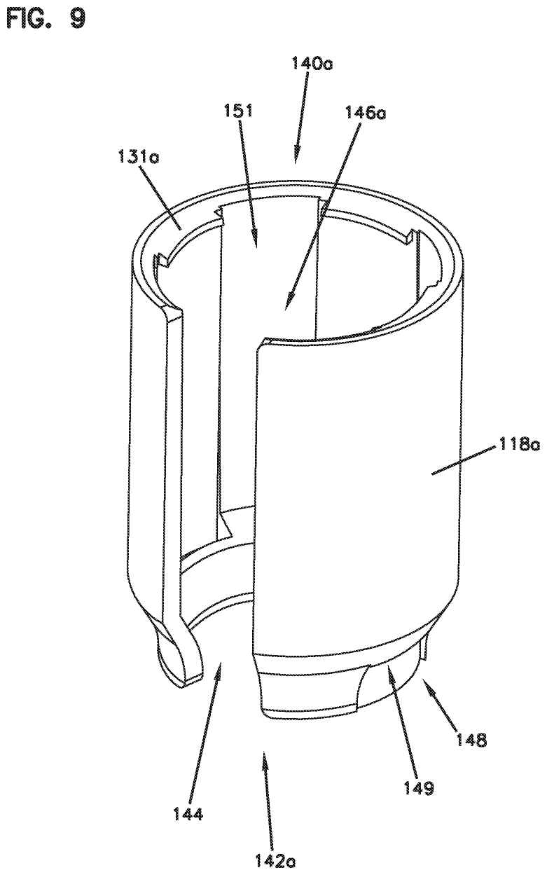

FIGS. 8 and 9 illustrate the cover 118a isolated from the fiber-optic connection assembly 100. The cover 118a has a connection end 140a and a cable receiving end 142a. The cover 118a includes a hollow passageway 146a extending between the connection end 140a and the receiving end 142a. The cover 118a receives the first fiber-optic connector 112a, the adapter 116 and the second fiber-optic connector 112b therein. At the connection end 140a the cover 118a includes a protrusion engagement arrangement 131a, for example a lip or an overhang extending inwardly. The protrusion engagement arrangement 131a can be discontinuous, as illustrated, in order to assist with a degree of flexibility of the cover 118a. Alternatively, it is contemplated that the protrusion engagement arrangement 131a can be a consistent overhang or lip.

As described in the embodiment in FIGS. 1 and 2, when the cover 118a is secured over the fiber-optic connection assembly the protrusion engagement arrangement 131a releasably engages the protrusion 128 on the adapter 116 on a side opposite the drop cable 114 to inhibit the cover from axial movement toward and along the direction of the drop cable.

The illustrated cover 118a can have a monolithic single-body construction that is generally rigid. The illustrated cover 118a can have a sleeve-like body with a generally circumferential or collar-like geometry, for example a generally cylindrical shape with one consistent construction. The illustrated cover 118a can include a cable-receiving channel 144 that extends from the connection end 140a to the receiving end 142a. In use, a length of the drop cable 114, away from the second fiber-optic connector 112b and the adapter 116, is inserted through the channel 144. Once the cable 114 is inserted through the channel 144 and into the hollow passageway 146a, the cover 118a can be forced over the second fiber-optic connector 112b and onto the adapter 116. Force is applied to the cover 118a, in a direction away from the drop cable 114, to snap the protrusion engagement arrangement 131a over and past the protrusion 128. The channel 144 allows the cover 118a to flex slightly when the protrusion engagement arrangement 131a is being snapped over and past the protrusion 128. Conversely, with sufficient pulling force the cover 118a can also be pulled in a direction toward the drop cable 114 to uncover the first and second fiber optic connectors 112a, 112b and the adapter 116, such that the protrusion engagement arrangement 131a snaps over and out of engagement from the protrusion 128.

When the cover 118a is snapped over the adapter 116 and the protrusion engagement arrangement 131a axially engages the protrusion 128, the cover 118a can still be freely rotated about the adapter 116. This relationship further inhibits unintended access to the first and second fiber optic connectors 112a, 112b and the adapter 116.

The illustrated cover 118a can also include a tapered region 148 that narrows toward the receiving end 142a. The tapered region 148 narrows to provide an axially inhibitory barrier over the adapter 116 when the protrusion 128 is releasably engaged with the protrusion engagement arrangement 131a.

As illustrated, the cover 118a can have a series of vents 149 which extend through the tapered region 148. The vents 149 can continue along a plurality of recessions 151 extending between tapered region 148 and the connection end 140a. The vents 149 and recessions 151 improve manufacturing capability and usefulness of the cover 118a, for example allowing molding through what is known as a straight pull. The combination of the vents 149, recessions 151 and discontinuous protrusion engagement arrangement 131a allows the cover 118a to flex slightly when being snapped over the protrusion 128 on the adapter 116.

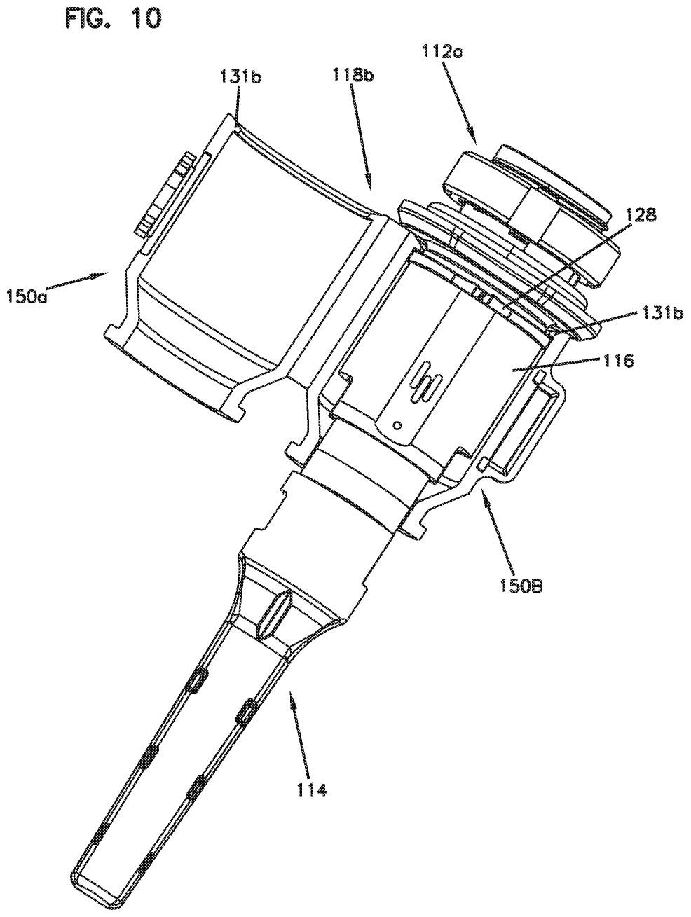

### B: Hinged Embodiment: FIGS. 10-12

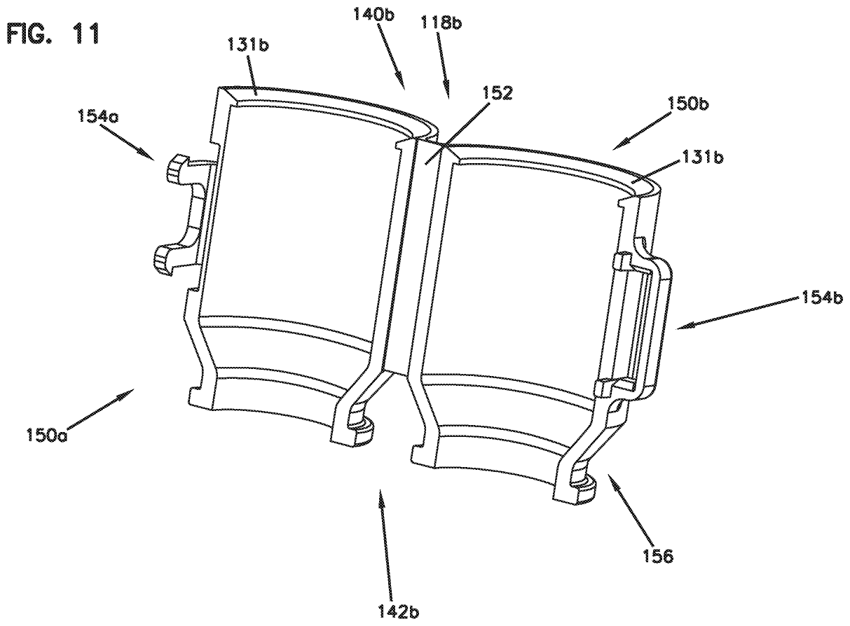

FIGS. 10-12 illustrate another example cover 118b (or shield) which functions to releasably secure over, and inhibit unintended access to, the fiber-optic connectors 112a and 112b and adapter 116, similarly to the embodiments described above. The illustrated cover 118b can be formed of two pivotally or hingedly connected sections or shells, similarly to a clamshell. As shown in FIGS. 10 and 11 specifically, the cover 118b can include a first shell 150a and a second shell 150b which are pivotally connected to each other through a hinge mechanism 152 extending therebetween. FIGS. 10 and 11 illustrate the example adapter 118b in an open condition with the first shell 150a and the second shell 150b hinged apart from each other. The illustrated cover 118b can include a connection end 140b and a receiving end 142b, similarly to the embodiment described above. Similarly to the embodiment above, the cover 118b can include a narrowing tapered region 156 at the receiving end 142b.

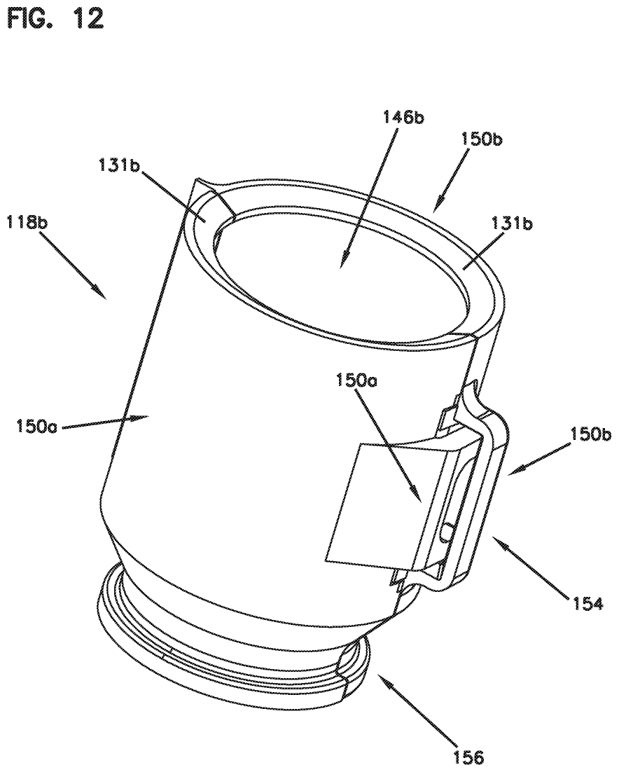

The illustrated cover 118b can include a fastener assembly 154 shown assembled (or interlocked) in FIG. 12. The fastener assembly 154 can include a first lock 154a positioned on the first shell 150a and a second lock 154b positioned on the second shell 150b, shown disassembled in FIGS. 10-11. The first 154a and second 154b locks can releasably interlock with each other to close the first 150a and second 150b shells of the cover 118b about the adapter 116.

The illustrated cover 118b, in its assembled condition shown in FIG. 12, has a generally circumferential geometry, for example a cylinder or collar. A hollow passageway 146b extends between the connection end 140b and the receiving end 142b.

As illustrated, each of the first and second shells 150a, 150b includes a protrusion engagement assembly 131b, for example an overhang or lip extending within the cover at the connection end 140b. As illustrated, the protrusion engagement assembly 131b can be generally continuous around the inner circumference of the cover 118b. When the cover 118b is closed and locked, as illustrated in FIG. 12, the protrusion engagement assembly 131b forms a continuous and circumferential geometry.

As particularly illustrated in FIG. 10, when the above first fiber-optic connector 112a, the second fiber-optic connector 112b and the adapter 116 are fastened together, one of the shells 150a, 150b of the cover 118a can be fitted about the adapter when the cover is in its open state. For example, the first and second fiber-optic connectors 112a and 112b can be set within the first shell 150b and then the second shell 150a can be hingedly rotated around the fiber-optic connection to interlock/assemble the fastening assembly 154. The protrusion engagement assembly 131b of the first shell 150b is axially engaged with the protrusion 128 on the adapter 116 on a side opposite the drop cable 114. The second shell 150a is then hingedly pivoted over the adapter 116 and the first lock 154a is interlocked with the second lock 154b. Once interlocked/assembled around the adapter 116, the protrusion engagement member 131b of the first and second shells 150a, 150b engage the protrusion 128 to inhibit axial movement, similarly to the embodiments described above.

In use, the protrusion engagement assembly 131b on both first and second shells 150a, 150b is axially engaged with the protrusion 128 on a side opposite the drop cable 114. The cover 118b can then be removed from the adapter 116 only by unlocking the first and second locks 154a, 154b from each other and hingedly pivoting the first shell 150a away from the second shell 150b.

When the cover 118b is secured over the adapter 116 and the protrusion engagement arrangement 131b axially engages the protrusion 128, the cover 118b can still be freely rotated about the adapter 116. This relationship further inhibits unintended access to the first and second fiber optic connectors 112a, 112b and the adapter 116.

### C: Anchor and Shroud Embodiment: FIGS. 13-14

FIGS. 13-14 illustrate a fiber-optic connection assembly 200 which is similar to the fiber-optic connection assembly 100 described above in FIGS. 4-7. In particular, the fiber-optic connection assembly 200 preferably includes the same first and second fiber-optic connectors 112a, 112b and the adapter 116 described in the above embodiment. The drop cable 114 is also supported by the second fiber-optic connector 112b. The fiber-optic connection assembly 200 also includes a cover 218. The illustrated cover 218 is different from the covers described above in FIGS. 4-12, but the cover 218 similarly functions to inhibit access to the fastener securing the first and second fiber-optic connectors 112a, 112b and the adapter 116.

The illustrated fiber-optic connection assembly 200 is fixed between the drop terminal 102 and the bracket 104. As illustrated, the bracket 104 and the drop terminal 102 can be oriented along an axis V, and the fiber-optic connection assembly 200 and the drop cable 114 can be oriented along a different axis T. As shown, axis T can be oriented at an acute angle with respect to axis V, for example between about 30-60 degrees, preferably about 45 degrees.

The illustrated cover 218 can include a shield (or shroud) section 202 that is supported (or tethered) to an anchor (or fixation) section 204. The cover 200 is preferably a single-body construction of stiff (or rigid) material, such as metal or plastic.

The illustrated shield section 202 can define a passageway 210 extending therein to receive the first and second fiber-optic connectors 112a, 112b and the adapter 116. The shield section 202 can have a U-shaped geometry that defines a closed side and an open receiver 212 (mouth, or opening) providing access to the passageway 210. The shield section 202 can also have open front and rear ends providing access to the passageway 210. In use, as illustrated in FIG. 13, the first and second fiber-optic connectors 112a, 112b and the adapter 116 are inserted into the passageway 210 through the open receiver 212, such that the drop cable 114 exits through one of the open ends of the shield section 202.

The illustrated anchor section 204 includes a fixation arm 206 and a support arm 208. As shown, the support arm 208 can have a length L that extends between the fixation arm 208 and the shield section 202. The length L can vary depending on needs, as described below, but should be long enough to extend from the fiber-optic connectors 112a, 112b to a bottom surface of the terminal 102.

As illustrated, the support arm 208 extends along a planar axis Y, and the fixation arm 206 extends along a planar axis X. Planar axes X and Y can be perpendicularly oriented with respect to each other. The shield section 202 can be oriented along an axis Z. Axis Z is oriented differently from axes X and Y. For example axis Z can be oriented at an acute angle with respect to axis Y, for example between about 30-60 degrees, preferably about 45 degrees. Preferably, axis Z can be oriented co-axially, or at least in parallel to, axis T shown in FIG. 13.

FIG. 13 illustrates the terminal 102 releasably received within the bracket 104, as shown and described in FIG. 3. For purposes of illustration, FIG. 13 identifies the bracket 104 in outline form in order to see the interplay between the cover 218, the terminal 102 and the bracket.

In use, the shield section 202 is placed over the first and second fiber-optic connectors 112a, 112b and the adapter 116, which rest within the passageway 210. The anchor section 204 is then releasably fitted or fixed between the terminal 102 and the bracket 104. Specifically, the support arm 208 is aligned along a side of the terminal 102, and the fixation arm 206 is positioned along the bottom surface of the terminal. Preferably, the support arm 208 and the fixation arm 206 are positioned substantially flush against the respective sides or surfaces of the terminal 102. The terminal 102 and the cover 218 are then inserted into the bracket 104, such that the fixation arm 206 and the support arm 208 are positionally secured, for example with a friction fit or pinch fit, between the terminal and the bracket. Once the cover 218 and the terminal 102 are releasably secured within the bracket 104, the cover 218 cannot be removed or repositioned. In this respect, unless the terminal 102 is removed from the bracket 104, the cover 218 is fixed in position and inhibits access to the first and second fiber-optic connectors 112a, 112b and the adapter 116.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can” or “could,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

1. A fiber-optic connection assembly comprising:
a cable, a fastener, a fiber-optic connector and an adapter, the cable terminating with the fiber-optic connector and extending away from the adapter, the fiber-optic connector being removably connected to the adapter with the fastener, the adapter comprising a protrusion; and
a cover comprising a movement-inhibition arrangement, the cover being removably mounted over the fastener, and the cover being configured to inhibit unintended access to the fastener.

2. The fiber-optic connection assembly of claim 1, wherein the movement-inhibition arrangement is a protrusion-engagement arrangement removably engaged with the protrusion so that the cover is inhibited from axial movement along the cable away from the fiber-optic connector and the adapter.

3. The fiber-optic connection assembly of claim 1, wherein the cover comprises a passageway configured to removably receive at least a portion of the fiber-optic connector and at least a portion of the adapter.

4. The fiber-optic connection assembly of claim 1, wherein the fastener comprises a releasably-engaged connection between the fiber-optic connector and the adapter.

5. The fiber-optic connection assembly of claim 1, wherein the protrusion projects away from the adapter.

6. The fiber-optic connection assembly of claim 1, wherein the movement-inhibition arrangement is a lip, the lip being removably engaged with the protrusion.

7. The fiber-optic connection assembly of claim 6, wherein the lip is circumferential.

8. The fiber-optic connection assembly of claim 7, wherein the lip is discontinuous.

9. The fiber-optic connection assembly of claim 1, wherein the cover comprises a collar section and a tapered section, the collar section having a wider clearance than the tapered section.

10. The fiber-optic connection assembly of claim 1, wherein the cover is configured to rotate with respect to the fiber-optic connector and the adapter.

11. The fiber-optic connection assembly of claim 1, wherein the cover comprises a substantially rigid monolithic structure.

12. The fiber-optic connection assembly of claim 1, wherein the cover comprises a channel configured to allow the cable to be inserted therethrough.

13. The fiber-optic connection assembly of claim 1, wherein the cover comprises a channel defined by a clearance that is wider than the width of the cable and narrower than the width of the fiber-optic connector and the adapter.

14. The fiber-optic connection assembly of claim 1, wherein the cover comprises a channel extending along the entire length of the cover.

15. The fiber-optic connection assembly of claim 1, wherein the cover comprises a substantially circular cross-sectional geometry.

16. The fiber-optic connection assembly of claim 1, wherein the cover comprises a unitary structure.

17. The fiber-optic connection assembly of claim 1, wherein the cover comprises a pair of sections releasably connected to each other with a locking assembly.

18. The fiber-optic connection assembly of claim 17, wherein the pair of sections are pivotally connected to each other along a hinge.

19. The fiber-optic connection assembly of claim 1, wherein the cover comprises an open position and a closed position, the cover configured to be in the closed position when mounted about the fiber-optic connector and the adapter.

20. The fiber-optic connection assembly of claim 19, wherein the cover comprises a circular cross-sectional geometry when in the closed position.

21.-29. (canceled)
